(19) United States
(12) Patent Application Publication
(10) Pub. No.: US 2024/0364387 A1
(43) Pub. Date: Oct. 31, 2024

(54) CONFIGURING PARAMETERS OF A RECONFIGURABLE SURFACE

(71) Applicant: QUALCOMM Incorporated, San Diego, CA (US)

(72) Inventors: Wei XI, Beijing (CN); Yu ZHANG, San Diego, CA (US); Chao WEI, Beijing (CN); Min HUANG, Beijing (CN); Hao XU, Beijing (CN); Danlu ZHANG, San Diego, CA (US)

(21) Appl. No.: 18/291,141

(22) PCT Filed: Sep. 17, 2021
(86) PCT No.: PCT/CN2021/119064

§ 371 Date: Jan. 22, 2024

(51) Int. Cl. H04B 7/04; H04L 5/00; H04W 72/20

(52) U.S. Cl. CPC H04B 7/04013; H04L 5/0048; H04W 72/20

(57) ABSTRACT

Methods, systems, and devices for wireless communications are described. For instance, a base station may transmit, to a user equipment (UE), control signaling indicating a configuration for transmitting a reference signal for reconfigurable surface configuration. The base station may receive, via a reconfigurable surface, the reference signal based on transmitting the control signaling. For instance, the reconfigurable surface may reflect the reference signal to the base station using a first configuration of the reconfigurable surface. The base station may transmit, to a controller of the reconfigurable surface, a set of parameters for configuring the reconfigurable surface to a second configuration for communications between the base station and the UE based on receiving the reference signal via the reconfigurable surface.

### CROSS REFERENCE

The present application is a 371 national stage filing of International PCT Application No. PCT/CN2021/119064 by XI et al. entitled “CONFIGURING PARAMETERS OF A RECONFIGURABLE SURFACE,” filed Sep. 17, 2021, which is assigned to the assignee hereof, and which is expressly incorporated by reference in its entirety herein.

### FIELD OF TECHNOLOGY

The following relates to wireless communications, including configuring parameters of a reconfigurable surface.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support configuring parameters of a reconfigurable surface. Generally, the described techniques provide for a base station to train a reconfigurable surface for communications between the UE and the base station. For instance, the base station may transmit, to the UE, control signaling indicating a configuration for transmitting a reference signal for reconfigurable surface configuration. The base station may receive, via a reconfigurable surface, the reference signal based on transmitting the control signaling. For instance, the reconfigurable surface may reflect the reference signal to the base station using a first configuration of the reconfigurable surface. The base station may transmit, to a controller of the reconfigurable surface, a set of parameters for configuring the reconfigurable surface to a second configuration for communications between the base station and the UE based on receiving the reference signal via the reconfigurable surface.

A method for wireless communication at a base station is described. The method may include transmitting, to a user equipment (UE), control signaling indicating a configuration for transmitting a reference signal for reconfigurable surface configuration, receiving, via a reconfigurable surface, the reference signal based on transmitting the control signaling, and transmitting, to a controller of the reconfigurable surface, a set of parameters for configuring the reconfigurable surface for communications between the base station and the UE based on receiving the reference signal via the reconfigurable surface.

An apparatus for wireless communication at a base station is described. The apparatus may include a processor, memory coupled with the processor, and instructions stored in the memory. The instructions may be executable by the processor to cause the apparatus to transmit, to a UE, control signaling indicating a configuration for transmitting a reference signal for reconfigurable surface configuration, receive, via a reconfigurable surface, the reference signal based on transmitting the control signaling, and transmit, to a controller of the reconfigurable surface, a set of parameters for configuring the reconfigurable surface for communications between the base station and the UE based on receiving the reference signal via the reconfigurable surface.

Another apparatus for wireless communication at a base station is described. The apparatus may include means for transmitting, to a UE, control signaling indicating a configuration for transmitting a reference signal for reconfigurable surface configuration, means for receiving, via a reconfigurable surface, the reference signal based on transmitting the control signaling, and means for transmitting, to a controller of the reconfigurable surface, a set of parameters for configuring the reconfigurable surface for communications between the base station and the UE based on receiving the reference signal via the reconfigurable surface.

A non-transitory computer-readable medium storing code for wireless communication at a base station is described. The code may include instructions executable by a processor to transmit, to a UE, control signaling indicating a configuration for transmitting a reference signal for reconfigurable surface configuration, receive, via a reconfigurable surface, the reference signal based on transmitting the control signaling, and transmit, to a controller of the reconfigurable surface, a set of parameters for configuring the reconfigurable surface for communications between the base station and the UE based on receiving the reference signal via the reconfigurable surface.

Some examples of the method, apparatuses, and non-transitory computer-readable medium described herein may further include operations, features, means, or instructions for transmitting, to the controller of the reconfigurable surface, a phase ramp indicator indicating a portion of the reconfigurable surface, where receiving the reference signal associated with the portion of the reconfigurable surface may be based on transmitting the phase ramp indicator.

In some examples of the method, apparatuses, and non-transitory computer-readable medium described herein, transmitting the set of parameters may include operations, features, means, or instructions for transmitting an indication of a co-phase for a portion of the reconfigurable surface.

In some examples of the method, apparatuses, and non-transitory computer-readable medium described herein, transmitting the set of parameters may include operations, features, means, or instructions for transmitting an indication of a phase ramp slope for a portion of the reconfigurable surface.

In some examples of the method, apparatuses, and non-transitory computer-readable medium described herein, the reference signal may be associated with a portion of the reconfigurable surface and the method, apparatuses, and non-transitory computer-readable medium may include further operations, features, means, or instructions for transmitting, to the controller of the reconfigurable surface, an indication of a size of the portion of the reconfigurable surface, where receiving the reference signal associated with the portion of the reconfigurable surface may be based on transmitting the indication of the size of the portion.

In some examples of the method, apparatuses, and non-transitory computer-readable medium described herein, the reference signal includes a sounding reference signal.

A method for wireless communication at a controller of a reconfigurable surface is described. The method may include reflecting, using a first configuration of the reconfigurable surface, a reference signal to a base station that is transmitted from a UE and receiving, from the base station, a set of parameters for configuring the reconfigurable surface to a second configuration based on reflecting the reference signal to the base station.

An apparatus for wireless communication at a controller of a reconfigurable surface is described. The apparatus may include a processor, memory coupled with the processor, and instructions stored in the memory. The instructions may be executable by the processor to cause the apparatus to reflect, using a first configuration of the reconfigurable surface, a reference signal to a base station that is transmitted from a UE and receive, from the base station, a set of parameters for configuring the reconfigurable surface to a second configuration based on reflecting the reference signal to the base station.

Another apparatus for wireless communication at a controller of a reconfigurable surface is described. The apparatus may include means for reflecting, using a first configuration of the reconfigurable surface, a reference signal to a base station that is transmitted from a UE and means for receiving, from the base station, a set of parameters for configuring the reconfigurable surface to a second configuration based on reflecting the reference signal to the base station.

A non-transitory computer-readable medium storing code for wireless communication at a controller of a reconfigurable surface is described. The code may include instructions executable by a processor to reflect, using a first configuration of the reconfigurable surface, a reference signal to a base station that is transmitted from a UE and receive, from the base station, a set of parameters for configuring the reconfigurable surface to a second configuration based on reflecting the reference signal to the base station.

Some examples of the method, apparatuses, and non-transitory computer-readable medium described herein may further include operations, features, means, or instructions for receiving, from the base station, a phase ramp indicator indicating a portion of the reconfigurable surface, where reflecting the reference signal associated with the portion of the reconfigurable surface may be based on receiving the phase ramp indicator.

In some examples of the method, apparatuses, and non-transitory computer-readable medium described herein, receiving the set of parameters may include operations, features, means, or instructions for receiving an indication of a co-phase for a portion of the reconfigurable surface.

In some examples of the method, apparatuses, and non-transitory computer-readable medium described herein, receiving the set of parameters may include operations, features, means, or instructions for receiving an indication of a phase ramp slope for a portion of the reconfigurable surface.

In some examples of the method, apparatuses, and non-transitory computer-readable medium described herein, the reference signal may be associated with a portion of the reconfigurable surface and the method, apparatuses, and non-transitory computer-readable medium may include further operations, features, means, or instructions for receiving, from the base station, an indication of a size of the portion of the reconfigurable surface, where reflecting the reference signal associated with the first portion of the reconfigurable surface may be based on receiving the indication of the size of the first portion.

Some examples of the method, apparatuses, and non-transitory computer-readable medium described herein may further include operations, features, means, or instructions for subdividing a surface of the reconfigurable surface into a set of portions based on receiving the indication of the size of the portion, where the set of portions includes the portion, and where each portion of the set of portions may have the size of the portion.

In some examples of the method, apparatuses, and non-transitory computer-readable medium described herein, each portion of the set of portions may be associated with a respective set of elements and the method, apparatuses, and non-transitory computer-readable medium may include further operations, features, means, or instructions for interpolating at least one element of the set of elements of the portion with at least one other element of the set of elements of the portion and reflecting a transmission between the base station and the UE based on the interpolating.

In some examples of the method, apparatuses, and non-transitory computer-readable medium described herein, each portion of the set of portions may be associated with a respective set of elements and the method, apparatuses, and non-transitory computer-readable medium may include further operations, features, means, or instructions for interpolating at least one element of the set of elements of the portion with at least one element of another set of elements of another portion of the set of portions and reflecting a transmission between the base station and the UE based on the interpolating.

In some examples of the method, apparatuses, and non-transitory computer-readable medium described herein, the reference signal includes a sounding reference signal.

Some examples of the method, apparatuses, and non-transitory computer-readable medium described herein may further include operations, features, means, or instructions for determining a phase shift for each element in a portion of the reconfigurable surface based on the set of parameters and reflecting a transmission between the base station and the UE based on determining the phase shift.

### BRIEF DESCRIPTION OF THE DRAWINGS

FIG. 1 illustrates an example of a wireless communications system that supports configuring parameters of a reconfigurable surface in accordance with aspects of the present disclosure.

FIG. 2 illustrates an example of a wireless communications system that supports configuring parameters of a reconfigurable surface in accordance with aspects of the present disclosure.

FIG. 3 illustrates an example of a training procedure that supports configuring parameters of a reconfigurable surface in accordance with aspects of the present disclosure.

FIG. 4 illustrates an example of a training procedure that supports configuring parameters of a reconfigurable surface in accordance with aspects of the present disclosure.

FIG. 5 illustrates an example of a process flow that supports configuring parameters of a reconfigurable surface in accordance with aspects of the present disclosure.

FIGS. 6 and 7 show block diagrams of devices that support configuring parameters of a reconfigurable surface in accordance with aspects of the present disclosure.

FIG. 8 shows a block diagram of a communications manager that supports configuring parameters of a reconfigurable surface in accordance with aspects of the present disclosure.

FIG. 9 shows a diagram of a system including a device that supports configuring parameters of a reconfigurable surface in accordance with aspects of the present disclosure.

FIGS. 10 and 11 show block diagrams of devices that support configuring parameters of a reconfigurable surface in accordance with aspects of the present disclosure.

FIG. 12 shows a block diagram of a communications manager that supports configuring parameters of a reconfigurable surface in accordance with aspects of the present disclosure.

FIG. 13 shows a diagram of a system including a device that supports configuring parameters of a reconfigurable surface in accordance with aspects of the present disclosure.

FIGS. 14 through 16 show flowcharts illustrating methods that support configuring parameters of a reconfigurable surface in accordance with aspects of the present disclosure.

### DETAILED DESCRIPTION

In some examples, a base station may communicate with a user equipment (UE) via a reconfigurable intelligent surface (RIS), which may reflect transmissions from the base station to the UE and from the UE to the base station. In some examples, the RIS may be modeled as a linear set of phase shifters that may be grouped into contiguous groups that referred to as units. For instance, a first unit may include the one or more phase shifters closest to one end of the linear set of phase shifters, a second unit may include the one or more phase shifters that are the next closest to the one end, and so on. In some examples, the units may be associated with one or more parameters, such as a phase ramp slope (PRS) of a unit or a co-phase between units. Statically configuring these parameters at a controller of the reconfigurable surface may fail to account for changes in the channel and/or in positioning between the base station and the UE.

The present disclosure is directed to methods of dynamically adjusting the one or more parameters. For instance, the base station may transmit, to the UE, control signaling indicating a configuration for transmitting a reference signal (e.g., a sounding reference signal (SRS)) for configuring the RIS. The UE may transmit the reference signal via the RIS, and the base station may transmit, to the controller, the one or more parameters. In some examples, the RIS may perform sequential unit-wise training, in which reference signal is sent for each individual unit while the remaining units are disabled, and/or inter-unit co-phase training, in which reference signal is sent for each pair of contiguous units while the remaining units are disabled. Accordingly, the base station may determine PRSs for each unit from the sequential unit-wise training and may determine co-phases for each contiguous pair of units, and the base station may transmit the PRSs and co-phases to the controller. The controller may use the one or more parameters (e.g., the PRSs and co-phases) to adjust the surface of the RIS.

Aspects of the disclosure are initially described in the context of wireless communications systems. Additional aspects of the disclosure are described in the context of training procedures and a process flow. Aspects of the disclosure are further illustrated by and described with reference to apparatus diagrams, system diagrams, and flowcharts that relate to configuring parameters of a reconfigurable surface.

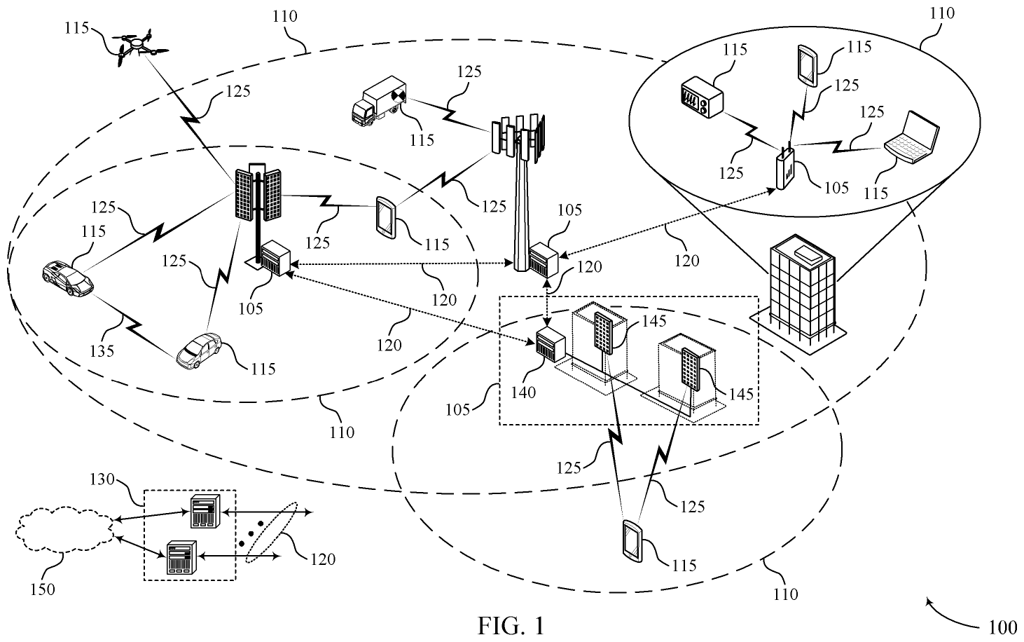

FIG. 1 illustrates an example of a wireless communications system 100 that supports configuring parameters of a reconfigurable surface in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, MIMO may be used to improve spectral efficiency (SE), which may be proportional to a number of antennas. In some examples, MIMO may be performed using a two-dimensional (2D) beam pointing to a far-field UE 115 (e.g., a UE 115 outside a threshold range from a base station 105 and/or a RIS). In other examples, holographic MIMO (H-MIMO) may be performed using a 2D beam pointing to a far-field UE 115. In other examples, H-MIMO may be performed using a 3D beam around a near-field UE 115 (e.g., a UE 115 within a threshold range of a base station 105 and/or a RIS).

In some examples, a density of users and/or a quantity of transmissions in a first frequency spectrum (e.g., a lower frequency spectrum) may be higher than in a second frequency spectrum (e.g., a higher frequency spectrum). However, the second frequency spectrum may have one or more properties that may decrease the efficiency of communications (e.g., a greater propagation attenuation than the first frequency spectrum). Employing H-MIMO (e.g., dense deployment for a given aperture size) by beamforming, may extend coverage and propagation distance (e.g., reducing propagation attenuation) for the second frequency spectrum. Additionally, performing H-MIMO may be associated with reduced power consumption (e.g., due to not using a power amplifier (PA) and/or a radio frequency (RF) chain).

In some examples (e.g., if a RIS is above a threshold size), a UE 115 may be within the near field of the RIS. Accordingly, joint control by a base station 105 (e.g., the base station communicating with the UE 115) and the RIS may enable H-MIMO based on the RIS which may provide the near-field UE with increased beamforming gain, post-detection SINR, throughput, or any combination thereof.

In some examples, a base station 105 may communicate with a UE 115 via a reconfigurable intelligent surface (RIS), which may reflect transmissions from the base station 105 to the UE 115 and from the UE 115 to the base station 105. In some examples, the RIS may be modeled as a linear set of phase shifters that may be grouped into contiguous groups that referred to as units. For instance, a first unit may include the one or more phase shifters closest to one end of the linear set of phase shifters, a second unit may include the one or more phase shifters that are the next closest to the one end, and so on. In some examples, the units may be associated with one or more parameters, such as a PRS of a unit or a co-phase between units. Statically configuring these parameters at a controller of the reconfigurable surface may fail to account for changes in the channel and/or in positioning between the base station 105 and the UE 115.

The present disclosure is directed to methods of dynamically adjusting the one or more parameters. For instance, the base station 105 may transmit, to the UE 115, control signaling indicating a configuration for transmitting a reference signal (e.g., a SRS) for configuring the RIS. The UE 115 may transmit the reference signal via the RIS, and the base station 105 may transmit, to the controller, the one or more parameters. In some examples, the RIS may perform sequential unit-wise training, in which reference signal is sent for each individual unit while the remaining units are disabled, and/or inter-unit co-phase training, in which reference signal is sent for each pair of contiguous units while the remaining units are disabled. Accordingly, the base station 105 may determine PRSs for each unit from the sequential unit-wise training and may determine co-phases for each contiguous pair of units, and the base station 105 may transmit the PRSs and co-phases to the controller. The controller may use the one or more parameters (e.g., the PRSs and co-phases) to adjust the surface of the RIS.

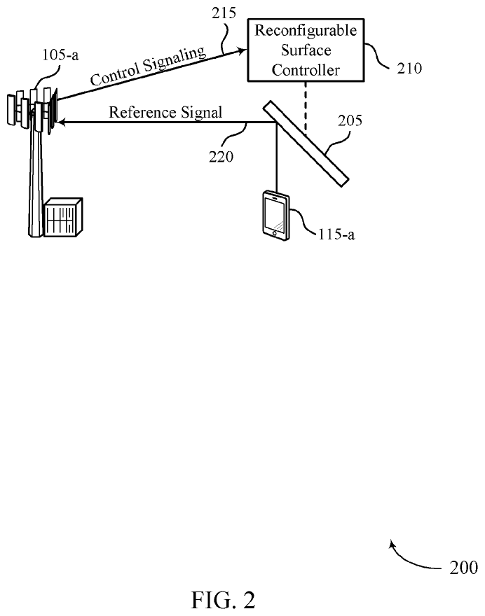

FIG. 2 illustrates an example of a wireless communications system 200 that supports configuring parameters of a reconfigurable surface in accordance with aspects of the present disclosure. In some examples, wireless communications system 200 may implement one or more aspects of wireless communications system 100. For instance, base station 105-a may be an example of a base station 105 as described with reference to FIG. 1 and UE 115-a may be an example of a UE 115 as described with reference to FIG. 1.

Base station 105-a may be configured to communicate with UE 115-a via reconfigurable surface 205. For instance, reconfigurable surface 205 may reflect transmissions from base station 105-a to UE 115-a and from UE 115-a to base station 105-a. Controller 210 (e.g., a reconfigurable surface controller) may be coupled with the reconfigurable surface 205 and may be configured to communicate with base station 105-a and/or UE 115-a. The controller 210 may be configured to adjust one or more parameters of the reconfigurable surface 205.

In some examples, the reconfigurable surface 205 (e.g., a RIS) may have one or more constraints. For instance, the reconfigurable surface 205 (e.g., or a controller 210 of the reconfigurable surface 205) may not be capable of transmitting and detecting signals. Accordingly, the effect of phase shifting may not be measured by the controller 210 of the reconfigurable surface 205 (e.g., phase shifting may be measured by base station 105-a or UE 115-a.

In some examples, the reconfigurable surface 205 may be modeled as a series of phase shifters. An incoming transmission (e.g., an incoming wave) may arrive at the reconfigurable surface 205 with angle of arrival (AoA) α (e.g., the phase arriving at the reconfigurable surface 205). The amount by which the phase of the transmission is shifted by each phase shifter n may be defined as

$$Φ ( α ) = \frac{2 π}{λ} ( n - 1 ) d cos ( α ) ,$$

where n=1, 2, . . . , N, N is the total number of phase shifters, d is the distance between each phase shifter, and λ is a wavelength of the incoming transmission. In some examples, the phase shift may be determined as

$$Φ ( Δ ) = \frac{2 π}{λ} ( n - 1 ) d Δ ,$$

where Δ is the PRS. Accordingly, the outgoing transmission (e.g., outgoing wave) may have an angle of departure (AoD) defined as β=π−cos⁻¹(cos(α)+Δ).

In some examples, controller 210 may train the reconfigurable surface 205. For instance, the controller 210 may partition the reconfigurable surface 205 into multiple units based on a configured surface unit size. For instance, base station 105-a may transmit an indication of a unit number N, where the number of phase shifters in each unit (e.g., elements) is determined as L=M/N and where M is a total number of phase shifters. Alternatively, base station 105-a may transmit an indication of a unit size L, where the unit number N (e.g., the number of units) is determined as N=M/L. In some examples, UE 115-a may be in a near field of the reconfigurable surface 205 and/or in a far-field of each of the N units.

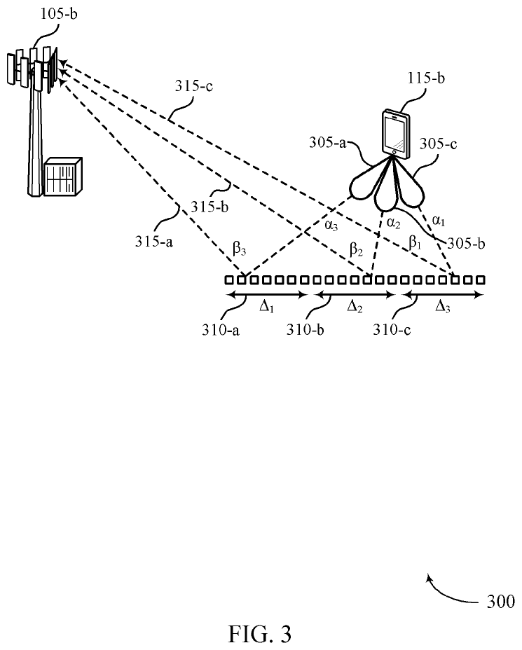

In some examples, controller 210 may perform sequential unit-wise training. For instance, UE 115-a may be configured to send reference signal 220 for each unit. Controller 210 may configure a phase ramp indicator (PRI) for each unit, where the PRI for one unit of the N units is set to true (e.g., the uth unit) and the PRIs for the remaining N−1 units of the N units is set to false. The controller 210 may perform a PRI-dependent operation for each of the units. For instance, if the PRI is set to true for a unit (e.g., the uth unit), the phase shifters associated with that unit may form a phase ramp Φ(Δ) based on the configured PRS Δ and may accordingly form an outgoing wave with AoD as β=π−cos⁻¹(cos(α)+Δ). If the PRI is set to false for a unit (e.g., the remaining of the N units), the controller 210 may apply random phase shifts to the phase shifters in the unit or may deactivate the phase shifters (e.g., elements) in the unit (e.g., short them to ground). Based on the measurements of the reference signal 220 (e.g., with different PRS), base station 105-a may obtain the best PRS (e.g., the PRS that is associated with a minimized or maximized metric among the tested PRSs) for each unit that has a PRI set to true (e.g., the uth unit), for which the best PRS is denoted as Δᵤ. Additional examples may be described herein, with reference to FIG. 3.

In some examples (e.g., in order to reduce the overhead of PRI signaling), a default PRI value may be defined, specified, or configured at controller 210. For instance, if PRI has a false default value, then when the controller 210 receives an explicit configuration that a uth unit is true, the controller 210 may determine that the other units have a false PRI value without receiving additional signaling. In one example, the reconfigurable surface 205 may include 8 units. In some such examples, a bitmap of [0 0 1 0 0 0 0 0] may indicate to activate the third unit and to deactivate the remaining 7 of the 8 units. Similarly, an index of 3 may indicate to activate the third unit and to deactivate the remaining 7 of the 8 units.

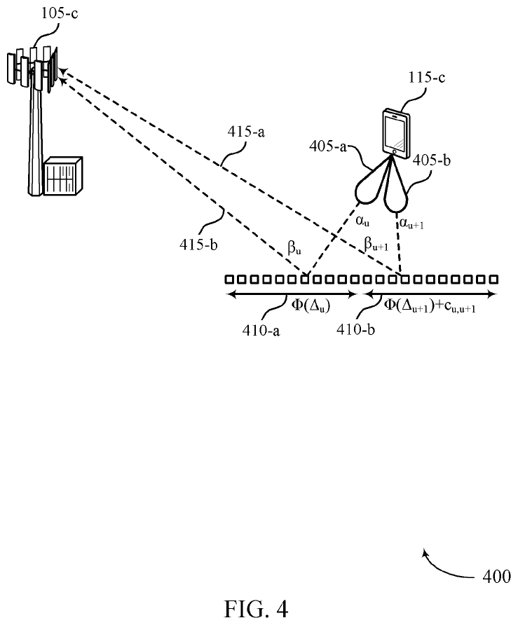

In some examples, controller 210 may perform sequential inter-unit co-phase training. For instance, UE 115-a may be configured to send reference signal 220 for each unit. Controller 210 may configure a phase ramp indicator (PRI) for each unit, where the PRI for multiple units (e.g., 2 units) of the N units is set to true (e.g., the uth unit and the (u+1)th unit) and the PRIs for the remaining units of the N units is set to false. The controller 210 may perform a PRI-dependent operation for each of the units. For instance, if the PRI is set to true for a unit (e.g., the uth unit and the (u+1)th unit), the phase shifters associated with that unit may form a phase ramp (e.g., based on the determined best PRS for the uth unit Φ(Δᵤ) and the (u+1)th unit Φ(Δᵤ₊₁), respectively, and a configured co-phase between the uth and (u+1)th units). If the PRI is set to false for a unit (e.g., the remaining of the N units), the controller 210 may apply random phase shifts to the phase shifters in the unit or may deactivate the phase shifters (e.g., elements) in the unit (e.g., short them to ground). Based on the measurements of the reference signal 220 (e.g., with different co-phases between the uth and (u+1)th unit), base station 105-a may obtain the best co-phase (e.g., the co-phase that is associated with a minimized or maximized metric among the tested co-phases) relative to uth and (u+1)th units (e.g., denoted by c_{u,u+1}). In some examples, controller 210 may perform this training for each pair of contiguous units among the N units. Additional examples may be described herein, for instance, with reference to FIG. 4.

In some examples, controller 210 may construct the phase shift for the entire reconfigurable surface 205 based on the determined best PRSs and best co-phases. For instance, Φ=[Φ(Δ₁), Φ(Δ₂)+c_{1,2}, (Δ₃)+c_{1,2}+c_{2,3}, . . . , Φ(Δ_{N})+Σᵢ₌₁^{N-1}c_{i,i+1}], where

$$Φ ( {Δ}_{u} ) = [ 0 , \frac{2 π}{λ} d {Δ}_{u} , … , \frac{2 π}{λ} ( L - 1 ) d {Δ}_{u} ] and u = 1 , 2 , … , N .$$

Additionally or alternatively, controller 210 may perform inter-element interpolation within and across units.

In some examples, base station 105-a may configure the controller 210 with one or more parameters via control signaling 215. For instance, base station 105-a may configure the controller 210 with a surface unit size L, a number of units N, a PRI for each unit of the N units, a PRS Δ for each of one or more of the N units, an inter-unit co-phase c for each of one or more of the pairs of contiguous units.

After the controller 210 receives the control signaling 215, the controller 210 may partition the reconfigurable surface 205 into multiple surface units based on the configured unit size and/or number of units. The controller may perform sequential unit-wise training and sequential inter-unit co-phase training as described herein. The controller 210 may construct the phase shift for the entire reconfigurable surface 205 according to Φ=[Φ(Δ₁), Φ(Δ₂)+c_{1,2}, (Δ₃)+c_{1,2}+c_{2,3}, . . . , Φ(Δ_{N})+Σᵢ₌₁^{N-1}c_{i,i+1}] and

$$Φ ( {Δ}_{u} ) = [ 0 , \frac{2 π}{λ} d {Δ}_{u} , … , \frac{2 π}{λ} ( L - 1 ) d {Δ}_{u} ]$$

The controller 210 may perform inter-element interpolation within and/or across units.

In some examples, the techniques described herein may be associated with one or more advantages. For instance, dynamically adjusting the PRS and/or co-phase of the units may enable base station 105-a and controller 210 to improve beamforming gain, post-detection signal to interference plus noise ratio (SINR), throughput or any combination thereof. Improving one or more of these metrics may be associated with increased wireless communications efficiency.

FIG. 3 illustrates an example of a training procedure 300 that supports configuring parameters of a reconfigurable surface in accordance with aspects of the present disclosure. In some examples, training procedure 300 may be implemented by one or more aspects of wireless communications systems 100 and/or 200. For instance, base station 105-b may be an example of a base station 105-a as described with reference to FIG. 2 and/or a base station 105 as described with reference to FIG. 1 and UE 115-b may be an example of a UE 115-a as described with reference to FIG. 2 and/or a UE 115 as described with reference to FIG. 1. Additionally or alternatively, units 310-a, 310-b, and 310-c may be an example of a surface of a reconfigurable surface 205 as described with reference to FIG. 2. In some examples, training procedure 300 may be an example of a sequential unit-wise training procedure as described herein, for instance, with reference to FIG. 2.

Initially, a controller of a reconfigurable surface may subdivide a surface of the reconfigurable surface into units 310-a, 310-b, and 310-c. Base station 105-b may configure the controller with a PRI set to true for unit 310-a and may configure the controller with a PRI set of false for units 310-b and 310-c. UE 115-b may transmit reference signal 315-a over beam 305-a. Reference signal 315-a (e.g., a SRS) may arrive at unit 310-a at an AoA α₁ from UE 115-b, may be shifted according to PRS Δ₁, and may depart at angle AoD β₁. Base station 105-b may receive reference signal 315-a and may receive additional reference signal associated with different PRSs. Base station 105-b may determine the best PRS Δ₁ and may transmit an indication of Δ₁ to the controller.

After receiving a reference signal 315-a, base station 105-b may configure the controller with a PRI set to true for unit 310-b and may configure the controller with a PRI set of false for units 310-a and 310-c. UE 115-b may transmit reference signal 315-b over beam 305-b. Reference signal 315-b (e.g., an SRS) may arrive at unit 310-b at an AoA α₂ from UE 115-b, may be shifted according to PRS Δ₂, and may depart at angle AoD β₂. Base station 105-b may receive reference signal 315-b and may receive additional reference signal associated with different PRSs. Base station 105-b may determine the best PRS Δ₂ and may transmit an indication of Δ₂ to the controller.

After receiving a reference signal 315-b, base station 105-b may configure the controller with a PRI set to true for unit 310-c and may configure the controller with a PRI set of false for units 310-a and 310-b. UE 115-b may transmit reference signal 315-c over beam 305-c. Reference signal 315-c (e.g., an SRS) may arrive at unit 310-c at an AoA α₃ from UE 115-b, may be shifted according to PRS Δ₃, and may depart at angle AoD β₃. Base station 105-b may receive reference signal 315-c and may receive additional reference signal associated with different PRSs. Base station 105-b may determine the best PRS Δ₃ and may transmit an indication of Δ₃ to the controller. In some examples, base station 105-a may transmit the indications of Δ₁, Δ₂, and Δ₃ after performing training on each of the units.

FIG. 4 illustrates an example of a training procedure 400 that supports configuring parameters of a reconfigurable surface in accordance with aspects of the present disclosure. In some examples, training procedure 400 may be implemented by one or more aspects of wireless communications systems 100 and/or 200. For instance, base station 105-c may be an example of a base station 105-a as described with reference to FIG. 2 and/or a base station 105 as described with reference to FIG. 1 and UE 115-c may be an example of a UE 115-a as described with reference to FIG. 2 and/or a UE 115 as described with reference to FIG. 1. Additionally or alternatively, units 410-a and 410-b may be an example of a surface of a reconfigurable surface 205 as described with reference to FIG. 2. In some examples, training procedure 400 may be an example of a sequential inter-unit co-phase training procedure as described herein, for instance, with reference to FIG. 2.

Initially, a controller of a reconfigurable surface may subdivide a surface of the reconfigurable surface into units 310-a, 310-b, and 310-c. Base station 105-b may configure the controller with a PRI set to true for units 410-a and 410-b and may configure the controller with a PRI set of false for any remaining units. UE 115-b may transmit reference signal 415-a over beam 405-a and may transmit reference signal 415-b (e.g., another SRS) over beam 405-b. Reference signal 415-a (e.g., a SRS) may arrive at unit 410-a at an AoA αᵤ from UE 115-b, may be shifted according to PRS Δᵤ, and may depart at angle AoD βᵤ. Similarly, reference signal 415-b (e.g., a SRS) may arrive at unit 410-b at an AoA αᵤ₊₁ from UE 115-b, may be shifted according to PRS Δᵤ₊₁ and a co-phase of the (u+1)th unit relative to unit u, and may depart at angle AoD βᵤ₊₁. Base station 105-b may receive reference signal 415-a and may receive reference signal 415-b. Base station 105-b may determine the best co-phase c_{u,u+1} and may transmit an indication of c_{u,u+1} to the controller.

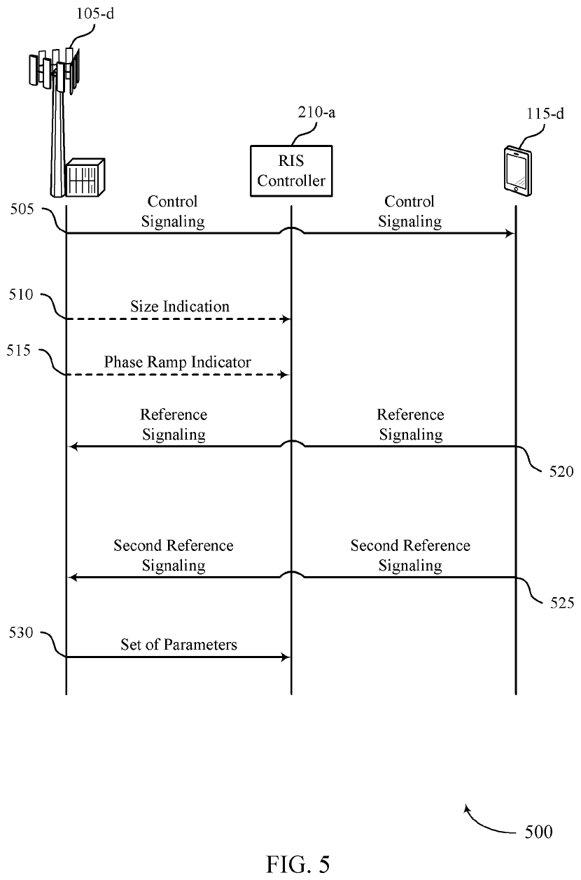

FIG. 5 illustrates an example of a process flow 500 that supports configuring parameters of a reconfigurable surface in accordance with aspects of the present disclosure. In some examples, process flow 500 may be implemented by one or more aspects of wireless communications systems 100 and/or 200. For instance, base station 105-d may be an example of a base station 105-a as described with reference to FIG. 2 and/or a base station 105 as described with reference to FIG. 1 and UE 115-d may be an example of a UE 115-a as described with reference to FIG. 2 and/or a UE 115 as described with reference to FIG. 1. Additionally or alternatively, controller 210-a may be an example of a controller 210 as described with reference to FIG. 2.

At 505, base station 105-d may transmit, to UE 115-d, control signaling indicating a configuration for transmitting a reference signal for reconfigurable surface configuration.

At 510, base station 105-d may transmit, to controller 210-a, an indication of a size of a first portion of the reconfigurable surface. In some examples, base station 105-d may subdivide a surface of the reconfigurable surface into a set of portions based on controller 210-a receiving the indication of the size of the first portion, where the set of portions includes the first portion, and where each portion of the set of portions has the size of the first portion.

At 515, base station 105-d may transmit, to controller 210-a, a first phase ramp indicator indicating the first portion of the reconfigurable surface. Additionally or alternatively, base station 105-d may transmit, to controller 210-a, a second phase ramp indicator indicating the second portion of the reconfigurable surface. In some examples, base station 105-d may indicate the size of the first portion and the first phase ramp indicator simultaneously (e.g., via simultaneous signaling). In some examples, controller 210-a may partition the surface of the reconfigurable surface before receiving the first phase ramp indicator (e.g., before receiving per-unit PRI indications).

At 520, UE 115-d may transmit, via the reconfigurable surface and to base station 105-d, the reference signal (e.g., reference signaling) based on receiving the control signaling. In some examples, the reference signal may be associated with the first portion of the reconfigurable surface. In some examples, receiving the reference signal via the reconfigurable surface is based on transmitting the first phase ramp indicator (e.g., at 510) and/or transmitting the size of the first portion. In some examples, the reference signal includes a sounding reference signal (e.g., an SRS). In some examples, controller 210-a may reflect, using a first configuration of the reconfigurable surface, the reference signal to base station 105-d that is transmitted from UE 115-d.

At 525, UE 115-d may transmit, via the reconfigurable surface and to base station 105-d, a second reference signal (e.g., SRS) associated with a second portion of the reconfigurable surface. In some examples, receiving the second reference signal associated with the second portion of the reconfigurable surface is based on transmitting the second phase ramp indicator (e.g., at 510). In some examples, the first portion of the reconfigurable surface includes a first set of units and the second portion of the reconfigurable surface includes a second set of units. In some examples, the first set of units and the second set of units may include a same unit. In other examples, the first set of units and the second set of units may be mutually exclusive. In some examples, the first portion of the reconfigurable surface may include a first unit and the second portion of the reconfigurable surface includes a second unit. In some examples, UE 115-d may reflect the second reference signal to base station 105-d that is transmitted from UE 115-d.

In some examples per-unit PRS training and per-unit-pair co-phase training may be sequentially performed. For instance, PRS training for a (u+1)th unit may be performed after PRS training for a uth unit. Additionally or alternatively, co-phase training between a uth and (u+1)th unit may be performed first, followed by co-phase training between a (u+1)th and a (u+2)th unit.

At 530, base station 105-d may transmit, to controller 210-a, a set of parameters for configuring the reconfigurable surface to a second configuration for communications between base station 105-d and UE 115-d based on receiving the reference signal via the reconfigurable surface. In some examples, transmitting the set of parameters is based on receiving a reference signal (e.g., a SRS) associated with the first portion of the reconfigurable surface and receiving the second reference signal (e.g., a SRS) associated with the second portion of the reconfigurable surface. In some examples, transmitting the set of parameters is based on the first set of units and the second set of units including at least one same unit. In some examples, transmitting the set of parameters may include transmitting an indication of a first co-phase for the first portion of the reconfigurable surface and an indication of a second co-phase for the second portion of the reconfigurable surface based on the first set of units and the second set of units including at least one same unit. In some examples, transmitting the set of parameters is based on the first unit being different than the second unit. In some examples, transmitting the set of parameters may include transmitting an indication of a first phase ramp slope for the first portion of the reconfigurable surface and an indication of a second phase ramp slope for the second portion of the reconfigurable surface based on the first unit being different than the second unit.

In some examples, each portion of the set of portions is associated with a respective set of elements. In some such examples, controller 210-a may interpolate at least one element of the set of elements of the first portion with at least one other element of the set of elements of the first portion and may reflect a transmission between base station 105-d and UE 115-d based on the interpolating. Additionally or alternatively, controller 210-a may interpolate at least one element of the set of elements of the first portion with at least one element of another set of elements of another portion of the set of portions and may reflect a transmission between base station 105-d and UE 115-d based on the interpolating. In some examples, controller 210-a may determine a phase shift for each element in a portion of the reconfigurable surface based on the set of parameters and may reflect a transmission between base station 105-d and UE 115-d based on determining the phase shift.

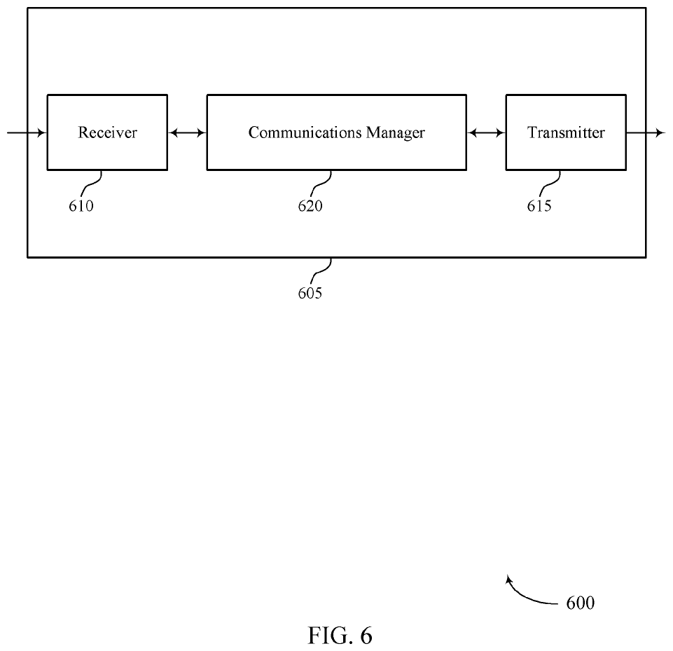

FIG. 6 shows a block diagram 600 of a device 605 that supports configuring parameters of a reconfigurable surface in accordance with aspects of the present disclosure. The device 605 may be an example of aspects of a base station 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to configuring parameters of a reconfigurable surface). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuring parameters of a reconfigurable surface). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of configuring parameters of a reconfigurable surface as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a base station in accordance with examples as disclosed herein. For example, the communications manager 620 may be configured as or otherwise support a means for transmitting, to a UE, control signaling indicating a configuration for transmitting a reference signal for reconfigurable surface configuration. The communications manager 620 may be configured as or otherwise support a means for receiving, via a reconfigurable surface, the reference signal based on transmitting the control signaling. The communications manager 620 may be configured as or otherwise support a means for transmitting, to a controller of the reconfigurable surface, a set of parameters for configuring the reconfigurable surface for communications between the base station and the UE based on receiving the reference signal via the reconfigurable surface.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for the device 605 to train a reconfigurable surface for communications between the device 605 and a UE. Training the reconfigurable surface may enable the reconfigurable surface to be positioned such that one or more communication parameters, such as SINR, may improve. Accordingly, the efficiency of communications may increase.

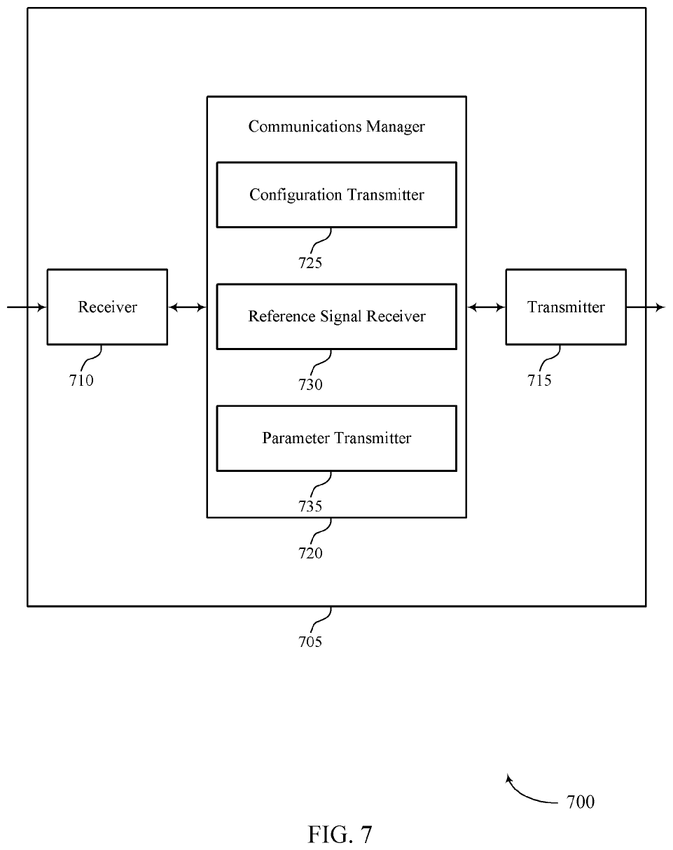

FIG. 7 shows a block diagram 700 of a device 705 that supports configuring parameters of a reconfigurable surface in accordance with aspects of the present disclosure. The device 705 may be an example of aspects of a device 605 or a base station 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to configuring parameters of a reconfigurable surface). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to configuring parameters of a reconfigurable surface). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of configuring parameters of a reconfigurable surface as described herein. For example, the communications manager 720 may include a configuration transmitter 725, a reference signal receiver 730, a parameter transmitter 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a base station in accordance with examples as disclosed herein. The configuration transmitter 725 may be configured as or otherwise support a means for transmitting, to a UE, control signaling indicating a configuration for transmitting a reference signal for reconfigurable surface configuration. The reference signal receiver 730 may be configured as or otherwise support a means for receiving, via a reconfigurable surface, the reference signal based on transmitting the control signaling. The parameter transmitter 735 may be configured as or otherwise support a means for transmitting, to a controller of the reconfigurable surface, a set of parameters for configuring the reconfigurable surface for communications between the base station and the UE based on receiving the reference signal via the reconfigurable surface.

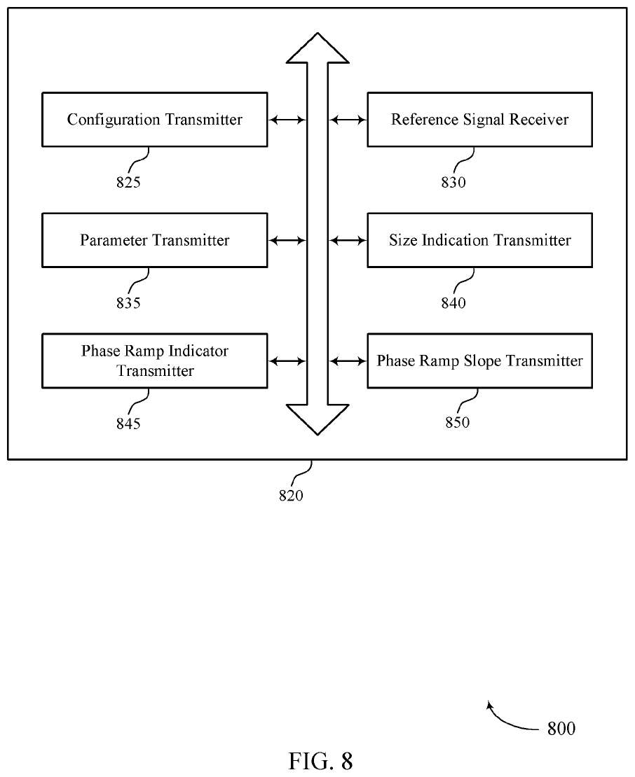

FIG. 8 shows a block diagram 800 of a communications manager 820 that supports configuring parameters of a reconfigurable surface in accordance with aspects of the present disclosure. The communications manager 820 may be an example of aspects of a communications manager 620, a communications manager 720, or both, as described herein. The communications manager 820, or various components thereof, may be an example of means for performing various aspects of configuring parameters of a reconfigurable surface as described herein. For example, the communications manager 820 may include a configuration transmitter 825, a reference signal receiver 830, a parameter transmitter 835, a size indication transmitter 840, a phase ramp indicator transmitter 845, phase ramp slope transmitter 850, or any combination thereof. Each of these components may communicate, directly or indirectly, with one another (e.g., via one or more buses).

The communications manager 820 may support wireless communication at a base station in accordance with examples as disclosed herein. The configuration transmitter 825 may be configured as or otherwise support a means for transmitting, to a UE, control signaling indicating a configuration for transmitting a reference signal for reconfigurable surface configuration. The reference signal receiver 830 may be configured as or otherwise support a means for receiving, via a reconfigurable surface, the reference signal based on transmitting the control signaling. The parameter transmitter 835 may be configured as or otherwise support a means for transmitting, to a controller of the reconfigurable surface, a set of parameters for configuring the reconfigurable surface for communications between the base station and the UE based on receiving the reference signal via the reconfigurable surface.

In some examples, the reference signal is associated with a first portion of the reconfigurable surface, and the reference signal receiver 830 may be configured as or otherwise support a means for receiving, via the reconfigurable surface, a second reference signal associated with a second portion of the reconfigurable surface, where transmitting the set of parameters is based on receiving the reference signal associated with the first portion of the reconfigurable surface and receiving the second reference signal associated with the second portion of the reconfigurable surface. In some examples (e.g., in training irrespective of per-unit PRS training or per-unit-pair co-phase training), the reference signal and the second reference signal may be two instances of a same periodic reference signal (e.g., an SRS).

In some examples, the phase ramp indicator transmitter 845 may be configured as or otherwise support a means for transmitting, to the controller of the reconfigurable surface, a first phase ramp indicator indicating the first portion of the reconfigurable surface, where receiving the reference signal associated with the first portion of the reconfigurable surface is based on transmitting the first phase ramp indicator. In some examples, the phase ramp indicator transmitter 845 may be configured as or otherwise support a means for transmitting, to the controller of the reconfigurable surface, a second phase ramp indicator indicating the second portion of the reconfigurable surface, where receiving the second reference signal associated with the second portion of the reconfigurable surface is based on transmitting the second phase ramp indicator.

In some examples, the first portion of the reconfigurable surface includes a first set of units and the second portion of the reconfigurable surface includes a second set of units. In some examples, transmitting the set of parameters is based on the first set of units and the second set of units including at least one same unit.

In some examples, to support transmitting the set of parameters, the parameter transmitter 835 may be configured as or otherwise support a means for transmitting an indication of a first co-phase for the first portion of the reconfigurable surface and an indication of a second co-phase for the second portion of the reconfigurable surface based on the first set of units and the second set of units including at least one same unit.

In some examples, the first portion of the reconfigurable surface includes a first unit and the second portion of the reconfigurable surface includes a second unit. In some examples, transmitting the set of parameters is based on the first unit being different than the second unit.

In some examples, to support transmitting the set of parameters, the parameter transmitter 835 and/or phase ramp slope transmitter 850 may be configured as or otherwise support a means for transmitting an indication of a first phase ramp slope for the first portion of the reconfigurable surface and an indication of a second phase ramp slope for the second portion of the reconfigurable surface based on the first unit being different than the second unit.

In some examples, the reference signal is associated with a first portion of the reconfigurable surface, and the size indication transmitter 840 may be configured as or otherwise support a means for transmitting, to the controller of the reconfigurable surface, an indication of a size of the first portion of the reconfigurable surface (e.g., L as described herein, where L=M/N), where receiving the reference signal associated with the first portion of the reconfigurable surface is based on transmitting the indication of the size of the first portion. In some examples, the size indication transmitter 840 may indicate a number of units (e.g., N as described herein, where L=M/N), where receiving the reference signal associated with the first portion of the reconfigurable surface is based on transmitting the number of units.

In some examples, the reference signal includes a sounding reference signal.

In some examples, the phase ramp indicator transmitter 845 may be configured as or otherwise support a means for transmitting, to the controller of the reconfigurable surface, a phase ramp indicator indicating a portion of the reconfigurable surface, where receiving the reference signal associated with the portion of the reconfigurable surface is based at least in part on transmitting the phase ramp indicator.

In some examples, to support transmitting the set of parameters, the parameter transmitter 835 may be configured as or otherwise support a means for transmitting an indication of a co-phase for a portion (e.g., a unit) of the reconfigurable surface.

In some examples, to support transmitting the set of parameters, the parameter transmitter 835 and/or phase ramp slope transmitter 850 may be configured as or otherwise support a means for transmitting an indication of a phase ramp slope for a portion (e.g., a unit) of the reconfigurable surface.

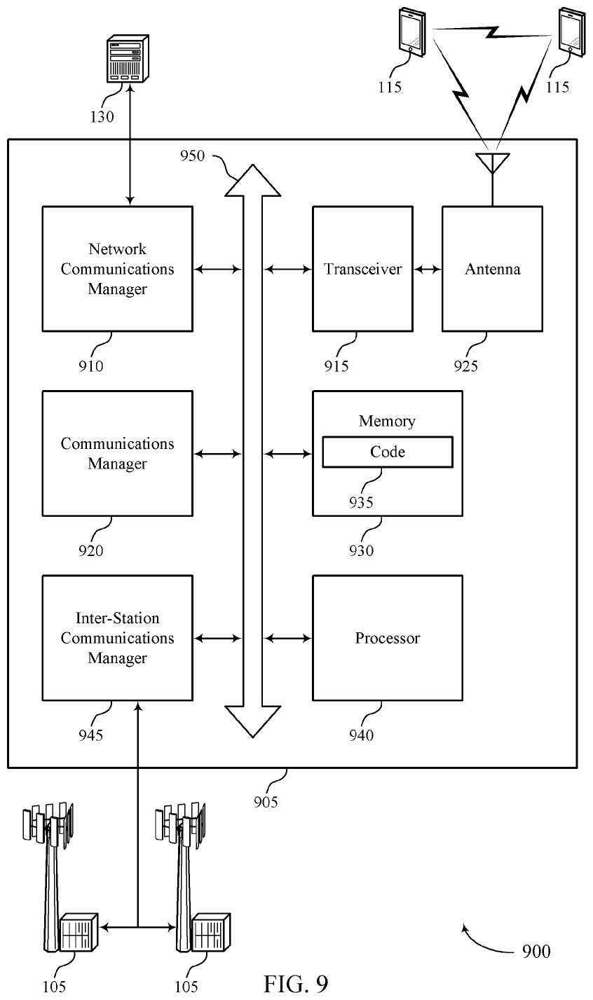

FIG. 9 shows a diagram of a system 900 including a device 905 that supports configuring parameters of a reconfigurable surface in accordance with aspects of the present disclosure. The device 905 may be an example of or include the components of a device 605, a device 705, or a base station 105 as described herein. The device 905 may communicate wirelessly with one or more base stations 105, UEs 115, or any combination thereof. The device 905 may include components for bi-directional voice and data communications including components for transmitting and receiving communications, such as a communications manager 920, a network communications manager 910, a transceiver 915, an antenna 925, a memory 930, code 935, a processor 940, and an inter-station communications manager 945. These components may be in electronic communication or otherwise coupled (e.g., operatively, communicatively, functionally, electronically, electrically) via one or more buses (e.g., a bus 950).

The network communications manager 910 may manage communications with a core network 130 (e.g., via one or more wired backhaul links). For example, the network communications manager 910 may manage the transfer of data communications for client devices, such as one or more UEs 115.

In some cases, the device 905 may include a single antenna 925. However, in some other cases the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random-access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic input/output system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting configuring parameters of a reconfigurable surface). For example, the device 905 or a component of the device 905 may include a processor 940 and memory 930 coupled to the processor 940, the processor 940 and memory 930 configured to perform various functions described herein.

The inter-station communications manager 945 may manage communications with other base stations 105, and may include a controller or scheduler for controlling communications with UEs 115 in cooperation with other base stations 105. For example, the inter-station communications manager 945 may coordinate scheduling for transmissions to UEs 115 for various interference mitigation techniques such as beamforming or joint transmission. In some examples, the inter-station communications manager 945 may provide an X2 interface within an LTE/LTE-A wireless communications network technology to provide communication between base stations 105.

The communications manager 920 may support wireless communication at a base station in accordance with examples as disclosed herein. For example, the communications manager 920 may be configured as or otherwise support a means for transmitting, to a UE, control signaling indicating a configuration for transmitting a reference signal for reconfigurable surface configuration. The communications manager 920 may be configured as or otherwise support a means for receiving, via a reconfigurable surface, the reference signal based on transmitting the control signaling. The communications manager 920 may be configured as or otherwise support a means for transmitting, to a controller of the reconfigurable surface, a set of parameters for configuring the reconfigurable surface for communications between the base station and the UE based on receiving the reference signal via the reconfigurable surface.

By including or configuring the communications manager 920 in accordance with examples as described herein, the device 905 may support techniques for the device 905 to train a reconfigurable surface for communications between the device 905 and a UE. Training the reconfigurable surface may enable the reconfigurable surface to be positioned such that one or more communication parameters, such as SINR, may improve. Accordingly, the efficiency of communications may increase.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of configuring parameters of a reconfigurable surface as described herein, or the processor 940 and the memory 930 may be otherwise configured to perform or support such operations.

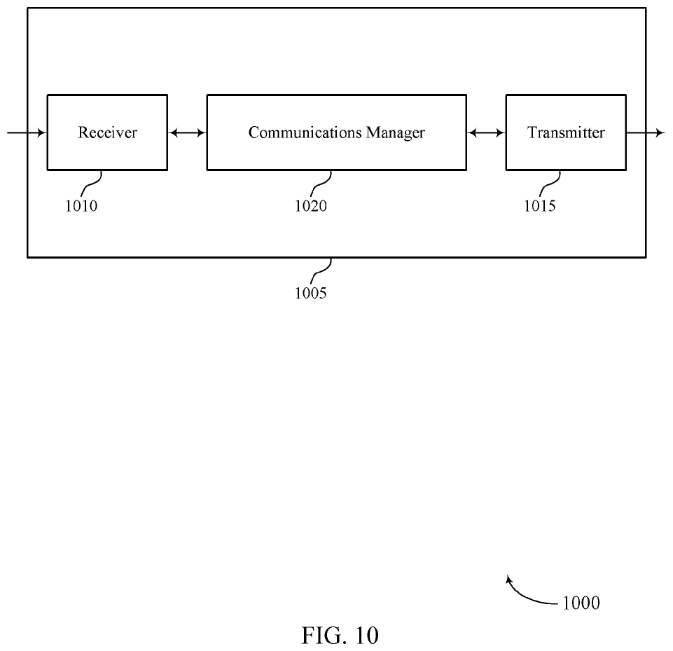

FIG. 10 shows a block diagram 1000 of a device 1005 that supports configuring parameters of a reconfigurable surface in accordance with aspects of the present disclosure. The device 1005 may be an example of aspects of a reconfigurable surface as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to configuring parameters of a reconfigurable surface). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to configuring parameters of a reconfigurable surface). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of configuring parameters of a reconfigurable surface as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a controller of a reconfigurable surface in accordance with examples as disclosed herein. For example, the communications manager 1020 may be configured as or otherwise support a means for reflecting, using a first configuration of the reconfigurable surface, reference signal to a base station that is transmitted from a UE. The communications manager 1020 may be configured as or otherwise support a means for receiving, from the base station, a set of parameters for configuring the reconfigurable surface to a second configuration based on reflecting the reference signal to the base station.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for the device 1005 to train a reconfigurable surface for communications between a base station and a UE. Training the reconfigurable surface may enable the reconfigurable surface to be positioned such that one or more communication parameters, such as SINR, may improve. Accordingly, the efficiency of communications may increase.

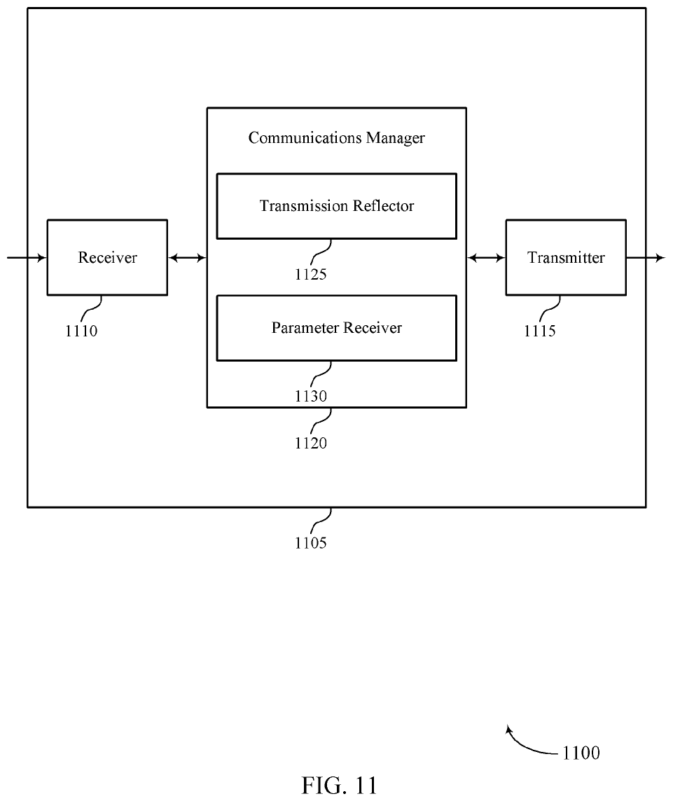

FIG. 11 shows a block diagram 1100 of a device 1105 that supports configuring parameters of a reconfigurable surface in accordance with aspects of the present disclosure. The device 1105 may be an example of aspects of a device 1005 or a reconfigurable surface 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to configuring parameters of a reconfigurable surface). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to configuring parameters of a reconfigurable surface). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of configuring parameters of a reconfigurable surface as described herein. For example, the communications manager 1120 may include a transmission reflector 1125 a parameter receiver 1130, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a controller of a reconfigurable surface in accordance with examples as disclosed herein. The transmission reflector 1125 may be configured as or otherwise support a means for reflecting, using a first configuration of the reconfigurable surface, reference signal to a base station that is transmitted from a UE. The parameter receiver 1130 may be configured as or otherwise support a means for receiving, from the base station, a set of parameters for configuring the reconfigurable surface to a second configuration based on reflecting the reference signal to the base station.

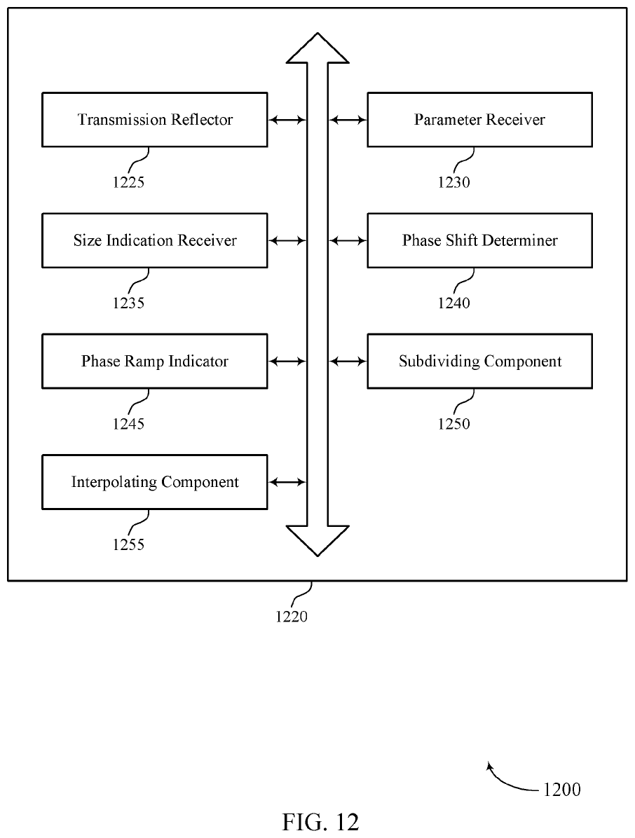

FIG. 12 shows a block diagram 1200 of a communications manager 1220 that supports configuring parameters of a reconfigurable surface in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of configuring parameters of a reconfigurable surface as described herein. For example, the communications manager 1220 may include a transmission reflector 1225, a parameter receiver 1230, a size indication receiver 1235, a phase shift determiner 1240, a phase ramp indicator 1245, a subdividing component 1250, an interpolating component 1255, or any combination thereof. Each of these components may communicate, directly or indirectly, with one another (e.g., via one or more buses).

The communications manager 1220 may support wireless communication at a controller of a reconfigurable surface in accordance with examples as disclosed herein. The transmission reflector 1225 may be configured as or otherwise support a means for reflecting, using a first configuration of the reconfigurable surface, reference signal to a base station that is transmitted from a UE. The parameter receiver 1230 may be configured as or otherwise support a means for receiving, from the base station, a set of parameters for configuring the reconfigurable surface to a second configuration based on reflecting the reference signal to the base station.

In some examples, the reference signal is associated with a first portion of the reconfigurable surface, and the transmission reflector 1225 may be configured as or otherwise support a means for reflecting second reference signal to the base station that is transmitted from the UE, where the second reference signal is associated with a second portion of the reconfigurable surface, and where receiving the set of parameters is based on reflecting the reference signal associated with the first portion of the reconfigurable surface and the second reference signal associated with the second portion of the reconfigurable surface.

In some examples, the phase ramp indicator 1245 may be configured as or otherwise support a means for receiving, from the base station, a first phase ramp indicator indicating the first portion of the reconfigurable surface, where reflecting the reference signal associated with the first portion of the reconfigurable surface is based on receiving the first phase ramp indicator. In some examples, the phase ramp indicator 1245 may be configured as or otherwise support a means for receiving, from the base station, a second phase ramp indicator indicating the second portion of the reconfigurable surface, where reflecting the second reference signal associated with the second portion of the reconfigurable surface is based on receiving the second phase ramp indicator.

In some examples, the first portion of the reconfigurable surface includes a first set of units and the second portion of the reconfigurable surface includes a second set of units. In some examples, receiving the set of parameters is based on the first set of units and the second set of units including at least one same unit.

In some examples, to support receiving the set of parameters, the parameter receiver 1230 may be configured as or otherwise support a means for receiving an indication of a first co-phase for the first portion of the reconfigurable surface and indication of a second co-phase for the second portion of the reconfigurable surface based on the first set of units and the second set of units including at least one same unit.

In some examples, the first portion of the reconfigurable surface includes a first unit and the second portion of the reconfigurable surface includes a second unit. In some examples, receiving the set of parameters is based on the first unit being different than the second unit.

In some examples, to support receiving the set of parameters, the parameter receiver 1230 may be configured as or otherwise support a means for receiving an indication of a first phase ramp slope for the first portion of the reconfigurable surface and an indication of a second phase ramp slope for the second portion of the reconfigurable surface based on the first unit being different than the second unit.

In some examples, the reference signal is associated with a first portion of the reconfigurable surface, and the size indication receiver 1235 may be configured as or otherwise support a means for receiving, from the base station, an indication of a size of the first portion of the reconfigurable surface, where reflecting the reference signal associated with the first portion of the reconfigurable surface is based on receiving the indication of the size of the first portion.

In some examples, the subdividing component 1250 may be configured as or otherwise support a means for subdividing a surface of the reconfigurable surface into a set of portions based on receiving the indication of the size of the first portion, where the set of portions includes the first portion, and where each portion of the set of portions has the size of the first portion.

In some examples, each portion of the set of portions is associated with a respective set of elements, and the interpolating component 1255 may be configured as or otherwise support a means for interpolating at least one element of the set of elements of the first portion with at least one other element of the set of elements of the first portion. In some examples, each portion of the set of portions is associated with a respective set of elements, and the transmission reflector 1225 may be configured as or otherwise support a means for reflecting a transmission between the base station and the UE based on the interpolating.

In some examples, each portion of the set of portions is associated with a respective set of elements, and the interpolating component 1255 may be configured as or otherwise support a means for interpolating at least one element of the set of elements of the first portion with at least one element of another set of elements of another portion of the set of portions. In some examples, each portion of the set of portions is associated with a respective set of elements, and the transmission reflector 1225 may be configured as or otherwise support a means for reflecting a transmission between the base station and the UE based on the interpolating.

In some examples, the reference signal includes a sounding reference signal.

In some examples, the phase shift determiner 1240 may be configured as or otherwise support a means for determining a phase shift for each element in a portion of the reconfigurable surface based on the set of parameters. In some examples, the transmission reflector 1225 may be configured as or otherwise support a means for reflecting a transmission between the base station and the UE based on determining the phase shift.

In some examples, the phase ramp indicator 1245 may be configured as or otherwise support a means for receiving, from the base station, a phase ramp indicator indicating a portion of the reconfigurable surface, where reflecting the reference signal associated with the portion of the reconfigurable surface is based at least in part on receiving the phase ramp indicator.

In some examples, to support receiving the set of parameters, the parameter receiver 1230 may be configured as or otherwise support a means for receiving an indication of a co-phase for a portion of the reconfigurable surface.

In some examples, to support receiving the set of parameters, the parameter receiver 1230 may be configured as or otherwise support a means for receiving an indication of a phase ramp slope for a portion of the reconfigurable surface.

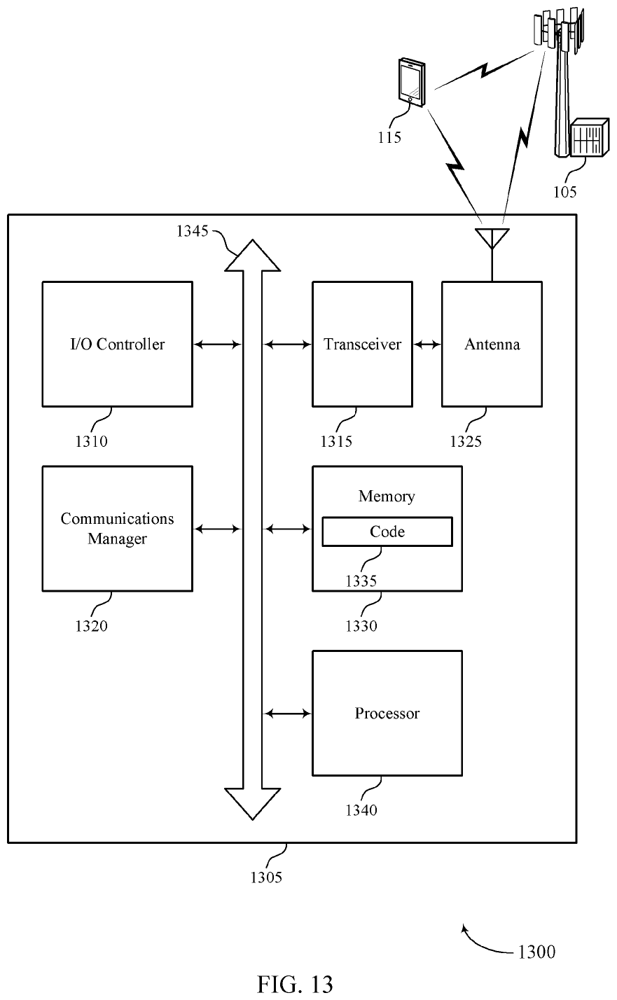

FIG. 13 shows a diagram of a system 1300 including a device 1305 that supports configuring parameters of a reconfigurable surface in accordance with aspects of the present disclosure. The device 1305 may be an example of or include the components of a device 1005, a device 1105, or a reconfigurable surface as described herein. The device 1305 may include components for bi-directional voice and data communications including components for transmitting and receiving communications, such as a communications manager 1320, an I/O controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting configuring parameters of a reconfigurable surface). For example, the device 1305 or a component of the device 1305 may include a processor 1340 and memory 1330 coupled to the processor 1340, the processor 1340 and memory 1330 configured to perform various functions described herein.

The communications manager 1320 may support wireless communication at a controller of a reconfigurable surface in accordance with examples as disclosed herein. For example, the communications manager 1320 may be configured as or otherwise support a means for reflecting, using a first configuration of the reconfigurable surface, reference signal to a base station that is transmitted from a UE. The communications manager 1320 may be configured as or otherwise support a means for receiving, from the base station, a set of parameters for configuring the reconfigurable surface to a second configuration based on reflecting the reference signal to the base station.

By including or configuring the communications manager 1320 in accordance with examples as described herein, the device 1305 may support techniques for the device 1305 to train a reconfigurable surface for communications between a base station and a UE. Training the reconfigurable surface may enable the reconfigurable surface to be positioned such that one or more communication parameters, such as SINR, may improve. Accordingly, the efficiency of communications may increase.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of configuring parameters of a reconfigurable surface as described herein, or the processor 1340 and the memory 1330 may be otherwise configured to perform or support such operations.

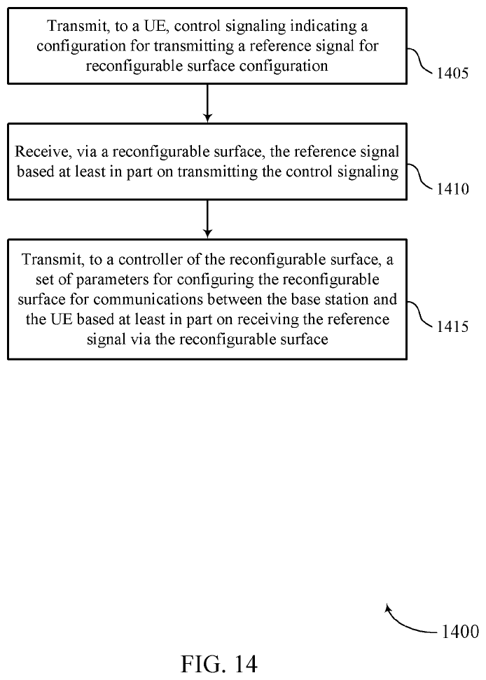

FIG. 14 shows a flowchart illustrating a method 1400 that supports configuring parameters of a reconfigurable surface in accordance with aspects of the present disclosure. The operations of the method 1400 may be implemented by a base station or its components as described herein. For example, the operations of the method 1400 may be performed by a base station 105 as described with reference to FIGS. 1 through 9. In some examples, a base station may execute a set of instructions to control the functional elements of the base station to perform the described functions. Additionally or alternatively, the base station may perform aspects of the described functions using special-purpose hardware.

At 1405, the method may include transmitting, to a UE, control signaling indicating a configuration for transmitting a reference signal for reconfigurable surface configuration. The operations of 1405 may be performed in accordance with examples as disclosed herein. In some examples, aspects of the operations of 1405 may be performed by a configuration transmitter 825 as described with reference to FIG. 8.

At 1410, the method may include receiving, via a reconfigurable surface, the reference signal based on transmitting the control signaling. The operations of 1410 may be performed in accordance with examples as disclosed herein. In some examples, aspects of the operations of 1410 may be performed by a reference signal receiver 830 as described with reference to FIG. 8.

At 1415, the method may include transmitting, to a controller of the reconfigurable surface, a set of parameters for configuring the reconfigurable surface for communications between the base station and the UE based on receiving the reference signal via the reconfigurable surface. The operations of 1415 may be performed in accordance with examples as disclosed herein. In some examples, aspects of the operations of 1415 may be performed by a parameter transmitter 835 as described with reference to FIG. 8.

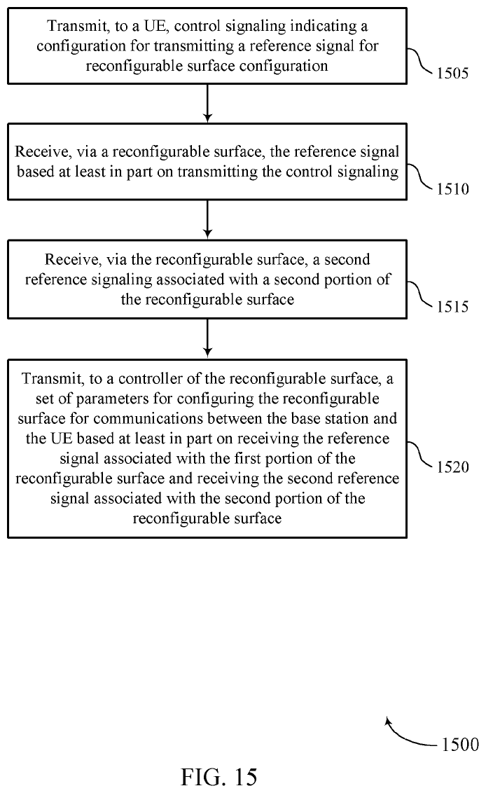

FIG. 15 shows a flowchart illustrating a method 1500 that supports configuring parameters of a reconfigurable surface in accordance with aspects of the present disclosure. The operations of the method 1500 may be implemented by a base station or its components as described herein. For example, the operations of the method 1500 may be performed by a base station 105 as described with reference to FIGS. 1 through 9. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, control signaling indicating a configuration for transmitting a reference signal for reconfigurable surface configuration. The operations of 1505 may be performed in accordance with examples as disclosed herein. In some examples, aspects of the operations of 1505 may be performed by a configuration transmitter 825 as described with reference to FIG. 8.

At 1510, the method may include receiving, via a reconfigurable surface, the reference signal based on transmitting the control signaling. The operations of 1510 may be performed in accordance with examples as disclosed herein. In some examples, aspects of the operations of 1510 may be performed by a reference signal receiver 830 as described with reference to FIG. 8.

At 1515, the method may include receiving, via the reconfigurable surface, a second reference signal associated with a second portion of the reconfigurable surface. The operations of 1515 may be performed in accordance with examples as disclosed herein. In some examples, aspects of the operations of 1515 may be performed by a reference signal receiver 830 as described with reference to FIG. 8.

At 1520, the method may include transmitting, to a controller of the reconfigurable surface, a set of parameters for configuring the reconfigurable surface for communications between the base station and the UE based at least in part on receiving the reference signal associated with the first portion of the reconfigurable surface and receiving the second reference signal associated with the second portion of the reconfigurable surface. The operations of 1520 may be performed in accordance with examples as disclosed herein. In some examples, aspects of the operations of 1520 may be performed by a parameter transmitter 835 as described with reference to FIG. 8.

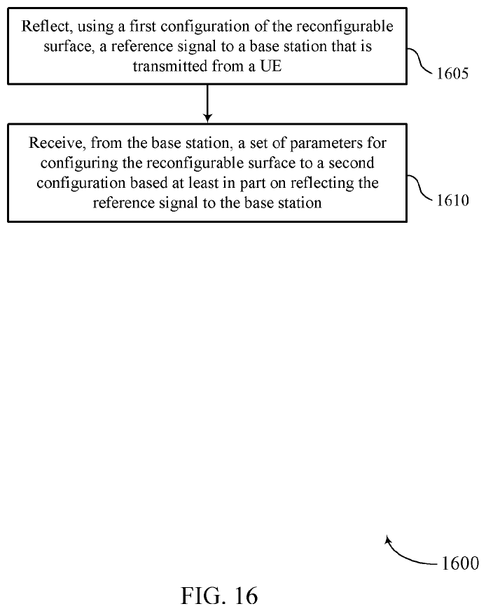

FIG. 16 shows a flowchart illustrating a method 1600 that supports configuring parameters of a reconfigurable surface in accordance with aspects of the present disclosure. The operations of the method 1600 may be implemented by a reconfigurable surface or its components as described herein. For example, the operations of the method 1600 may be performed by a reconfigurable surface as described with reference to FIGS. 1 through 5 and 10 through 13. In some examples, a reconfigurable surface may execute a set of instructions to control the functional elements of the reconfigurable surface to perform the described functions. Additionally or alternatively, the reconfigurable surface may perform aspects of the described functions using special-purpose hardware.

At 1605, the method may include reflecting, using a first configuration of the reconfigurable surface, a reference signal to a base station that is transmitted from a UE. The operations of 1605 may be performed in accordance with examples as disclosed herein. In some examples, aspects of the operations of 1605 may be performed by a transmission reflector 1225 as described with reference to FIG. 12.

At 1610, the method may include receiving, from the base station, a set of parameters for configuring the reconfigurable surface to a second configuration based on reflecting the reference signal to the base station. The operations of 1610 may be performed in accordance with examples as disclosed herein. In some examples, aspects of the operations of 1610 may be performed by a parameter receiver 1230 as described with reference to FIG. 12.

The following provides an overview of aspects of the present disclosure:

Aspect 1: A method for wireless communication at a base station, comprising: transmitting, to a UE, control signaling indicating a configuration for transmitting a reference signal for reconfigurable surface configuration; receiving, via a reconfigurable surface, the reference signal based at least in part on transmitting the control signaling; and transmitting, to a controller of the reconfigurable surface, a set of parameters for configuring the reconfigurable surface for communications between the base station and the UE based at least in part on receiving the reference signal via the reconfigurable surface.

Aspect 2: The method of aspect 1, further comprising: transmitting, to the controller of the reconfigurable surface, a phase ramp indicator indicating a portion of the reconfigurable surface, wherein receiving the reference signal associated with the portion of the reconfigurable surface is based at least in part on transmitting the phase ramp indicator.

Aspect 3: The method of any of aspects 1 through 2, wherein transmitting the set of parameters comprises: transmitting an indication of a co-phase for a portion of the reconfigurable surface.

Aspect 4: The method of any of aspects 1 through 3, wherein transmitting the set of parameters comprises: transmitting an indication of a phase ramp slope for a portion of the reconfigurable surface.

Aspect 5: The method of any of aspects 1 through 4, wherein the reference signal is associated with a portion of the reconfigurable surface, the method further comprising: transmitting, to the controller of the reconfigurable surface, an indication of a size of the portion of the reconfigurable surface, wherein receiving the reference signal associated with the portion of the reconfigurable surface is based at least in part on transmitting the indication of the size of the portion.

Aspect 6: The method of any of aspects 1 through 5, wherein the reference signal comprises a sounding reference signal.

Aspect 7: A method for wireless communication at a controller of a reconfigurable surface, comprising: reflecting, using a first configuration of the reconfigurable surface, a reference signal to a base station that is transmitted from a UE; and receiving, from the base station, a set of parameters for configuring the reconfigurable surface to a second configuration based at least in part on reflecting the reference signal to the base station.

Aspect 8: The method of aspect 7, further comprising: receiving, from the base station, a phase ramp indicator indicating a portion of the reconfigurable surface, wherein reflecting the reference signal associated with the portion of the reconfigurable surface is based at least in part on receiving the phase ramp indicator.

Aspect 9: The method of any of aspects 7 through 8, wherein receiving the set of parameters comprises: receiving an indication of a co-phase for a portion of the reconfigurable surface.

Aspect 10: The method of any of aspects 7 through 9, wherein receiving the set of parameters comprises: receiving an indication of a phase ramp slope for a portion of the reconfigurable surface.

Aspect 11: The method of any of aspects 7 through 10, wherein the reference signal is associated with a portion of the reconfigurable surface, the method further comprising: receiving, from the base station, an indication of a size of the portion of the reconfigurable surface, wherein reflecting the reference signal associated with the first portion of the reconfigurable surface is based at least in part on receiving the indication of the size of the first portion.

Aspect 12: The method of aspect 11, further comprising: subdividing a surface of the reconfigurable surface into a set of portions based at least in part on receiving the indication of the size of the portion, wherein the set of portions comprises the portion, and wherein each portion of the set of portions has the size of the portion.

Aspect 13: The method of aspect 12, wherein each portion of the set of portions is associated with a respective set of elements, the method further comprising: interpolating at least one element of the set of elements of the portion with at least one other element of the set of elements of the portion; and reflecting a transmission between the base station and the UE based at least in part on the interpolating.

Aspect 14: The method of any of aspects 12 through 13, wherein each portion of the set of portions is associated with a respective set of elements, the method further comprising: interpolating at least one element of the set of elements of the portion with at least one element of another set of elements of another portion of the set of portions; and reflecting a transmission between the base station and the UE based at least in part on the interpolating.

Aspect 15: The method of any of aspects 7 through 14, wherein the reference signal comprises a sounding reference signal.

Aspect 16: The method of any of aspects 7 through 15, further comprising: determining a phase shift for each element in a portion of the reconfigurable surface based at least in part on the set of parameters; and reflecting a transmission between the base station and the UE based at least in part on determining the phase shift.

Aspect 17: An apparatus for wireless communication at a base station, comprising a processor; memory coupled with the processor; and instructions stored in the memory and executable by the processor to cause the apparatus to perform a method of any of aspects 1 through 6.

Aspect 18: An apparatus for wireless communication at a base station, comprising at least one means for performing a method of any of aspects 1 through 6.

Aspect 19: A non-transitory computer-readable medium storing code for wireless communication at a base station, the code comprising instructions executable by a processor to perform a method of any of aspects 1 through 6.

Aspect 20: An apparatus for wireless communication at a controller of a reconfigurable surface, comprising a processor; memory coupled with the processor; and instructions stored in the memory and executable by the processor to cause the apparatus to perform a method of any of aspects 7 through 16.

Aspect 21: An apparatus for wireless communication at a controller of a reconfigurable surface, comprising at least one means for performing a method of any of aspects 7 through 16.

Aspect 22: A non-transitory computer-readable medium storing code for wireless communication at a controller of a reconfigurable surface, the code comprising instructions executable by a processor to perform a method of any of aspects 7 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a base station, comprising:
transmitting, to a user equipment (UE), control signaling indicating a configuration for transmitting a reference signal for reconfigurable surface configuration;
receiving, via a reconfigurable surface, the reference signal based at least in part on transmitting the control signaling; and
transmitting, to a controller of the reconfigurable surface, a set of parameters for configuring the reconfigurable surface for communications between the base station and the UE based at least in part on receiving the reference signal via the reconfigurable surface.

2. The method of claim 1, further comprising:
transmitting, to the controller of the reconfigurable surface, a phase ramp indicator indicating a portion of the reconfigurable surface, wherein receiving the reference signal associated with the portion of the reconfigurable surface is based at least in part on transmitting the phase ramp indicator.

3. The method of claim 1, wherein transmitting the set of parameters comprises:
transmitting an indication of a co-phase for a portion of the reconfigurable surface.

4. The method of claim 1, wherein transmitting the set of parameters comprises:
transmitting an indication of a phase ramp slope for a portion of the reconfigurable surface.

5. The method of claim 1, wherein the reference signal is associated with a portion of the reconfigurable surface, the method further comprising:
transmitting, to the controller of the reconfigurable surface, an indication of a size of the portion of the reconfigurable surface, wherein receiving the reference signal associated with the portion of the reconfigurable surface is based at least in part on transmitting the indication of the size of the portion.

6. The method of claim 1, wherein the reference signal comprises a sounding reference signal.

7. A method for wireless communication at a controller of a reconfigurable surface, comprising:
reflecting, using a first configuration of the reconfigurable surface, a reference signal to a base station that is transmitted from a user equipment (UE); and
receiving, from the base station, a set of parameters for configuring the reconfigurable surface to a second configuration based at least in part on reflecting the reference signal to the base station.

8. The method of claim 7, further comprising:
receiving, from the base station, a phase ramp indicator indicating a portion of the reconfigurable surface, wherein reflecting the reference signal associated with the portion of the reconfigurable surface is based at least in part on receiving the phase ramp indicator.

9. The method of claim 7, wherein receiving the set of parameters comprises:
receiving an indication of a co-phase for a portion of the reconfigurable surface.

10. The method of claim 7, wherein receiving the set of parameters comprises:
receiving an indication of a phase ramp slope for a portion of the reconfigurable surface.

11. The method of claim 7, wherein the reference signal is associated with a portion of the reconfigurable surface, the method further comprising:
receiving, from the base station, an indication of a size of the portion of the reconfigurable surface, wherein reflecting the reference signal associated with the first portion of the reconfigurable surface is based at least in part on receiving the indication of the size of the first portion.

12. The method of claim 11, further comprising:
subdividing a surface of the reconfigurable surface into a set of portions based at least in part on receiving the indication of the size of the portion, wherein the set of portions comprises the portion, and wherein each portion of the set of portions has the size of the portion.

13. The method of claim 12, wherein each portion of the set of portions is associated with a respective set of elements, the method further comprising:
interpolating at least one element of the set of elements of the portion with at least one other element of the set of elements of the portion; and
reflecting a transmission between the base station and the UE based at least in part on the interpolating.

14. The method of claim 12, wherein each portion of the set of portions is associated with a respective set of elements, the method further comprising:
interpolating at least one element of the set of elements of the portion with at least one element of another set of elements of another portion of the set of portions; and
reflecting a transmission between the base station and the UE based at least in part on the interpolating.

15. The method of claim 7, wherein the reference signal comprises a sounding reference signal.

16. The method of claim 7, further comprising:
determining a phase shift for each element in a portion of the reconfigurable surface based at least in part on the set of parameters; and
reflecting a transmission between the base station and the UE based at least in part on determining the phase shift.

17. An apparatus for wireless communication at a base station, comprising:
a processor;
memory coupled with the processor; and
instructions stored in the memory and executable by the processor to cause the apparatus to:
transmit, to a user equipment (UE), control signaling indicating a configuration for transmitting a reference signal for reconfigurable surface configuration;
receive, via a reconfigurable surface, the reference signal based at least in part on transmitting the control signaling; and
transmit, to a controller of the reconfigurable surface, a set of parameters for configuring the reconfigurable surface for communications between the base station and the UE based at least in part on receiving the reference signal via the reconfigurable surface.

18. The apparatus of claim 17, wherein the instructions are further executable by the processor to cause the apparatus to:
transmit, to the controller of the reconfigurable surface, a phase ramp indicator indicating a portion of the reconfigurable surface, wherein receiving the reference signal associated with the portion of the reconfigurable surface is based at least in part on transmitting the phase ramp indicator.

19. The apparatus of claim 17, wherein the instructions to receive the set of parameters are executable by the processor to cause the apparatus to:
receive an indication of a co-phase for a portion of the reconfigurable surface.

20. The apparatus of claim 17, wherein the instructions to receive the set of parameters are executable by the processor to cause the apparatus to:
receive an indication of a phase ramp slope for a portion of the reconfigurable surface.

21. The apparatus of claim 17, wherein the reference signal is associated with a portion of the reconfigurable surface, and the instructions are further executable by the processor to cause the apparatus to:
transmit, to the controller of the reconfigurable surface, an indication of a size of the portion of the reconfigurable surface, wherein receiving the reference signal associated with the portion of the reconfigurable surface is based at least in part on transmitting the indication of the size of the portion.

22. The apparatus of claim 17, wherein:
the reference signal comprises a sounding reference signal.

23. An apparatus for wireless communication at a controller of a reconfigurable surface, comprising:
a processor;
memory coupled with the processor; and
instructions stored in the memory and executable by the processor to cause the apparatus to:
reflect, using a first configuration of the reconfigurable surface, a reference signal to a base station that is transmitted from a user equipment (UE); and
receive, from the base station, a set of parameters for configuring the reconfigurable surface to a second configuration based at least in part on reflecting the reference signal to the base station.

24. The apparatus of claim 23, wherein the instructions are further executable by the processor to cause the apparatus to:
receive, from the base station, a phase ramp indicator indicating a portion of the reconfigurable surface, wherein reflecting the reference signal associated with the portion of the reconfigurable surface is based at least in part on receiving the phase ramp indicator.

25. The apparatus of claim 23, wherein the instructions to receive the one or more parameters are executable by the processor to cause the apparatus to:
receive an indication of a co-phase for a portion of the reconfigurable surface.

26. The apparatus of claim 23, wherein the instructions to receive the one or more parameters are executable by the processor to cause the apparatus to:
receive an indication of a phase ramp slope for a portion of the reconfigurable surface.

27. The apparatus of claim 23, wherein the reference signal is associated with a portion of the reconfigurable surface, and wherein the instructions are further executable by the processor to cause the apparatus to:
receive, from the base station, an indication of a size of the portion of the reconfigurable surface, wherein reflecting the reference signal associated with the first portion of the reconfigurable surface is based at least in part on receiving the indication of the size of the first portion.

28. The apparatus of claim 27, wherein the instructions are further executable by the processor to cause the apparatus to:
subdivide a surface of the reconfigurable surface into a set of portions based at least in part on receiving the indication of the size of the portion, wherein the set of portions comprises the portion, and wherein each portion of the set of portions has the size of the portion.

29. The apparatus of claim 28, wherein each portion of the set of portions is associated with a respective set of elements, and wherein the instructions are further executable by the processor to cause the apparatus to:
interpolate at least one element of the set of elements of the portion with at least one other element of the set of elements of the portion; and
reflect a transmission between the base station and the UE based at least in part on the interpolating.

30. The apparatus of claim 28, wherein each portion of the set of portions is associated with a respective set of elements.
